(19) United States
(12) Patent Application Publication
(10) Pub. No.: US 2025/0214305 A1
(43) Pub. Date: Jul. 3, 2025

(54) THREE-DIMENSIONAL PRINTING

(71) Applicant: Shenzhen Anker Smart Technology Co, Ltd., Shenzhen (CN)

(72) Inventor: Fan Wu, Shenzhen (CN)

(21) Appl. No.: 18/967,895

(22) Filed: Dec. 4, 2024

(30) Foreign Application Priority Data
Dec. 29, 2023 (CN) 202311871885.8

(51) Int. Cl. B29C 64/386; B29C 64/106; B33Y 10/00; B33Y 30/00; B33Y 50/02

(52) U.S. Cl. CPC B29C 64/386; B29C 64/106; B33Y 10/00; B33Y 50/02; B33Y 30/00

(57) ABSTRACT

Disclosed are a three-dimensional printed object, a method for printing a three-dimensional object, and a three-dimensional printer. The method comprises printing a first base printing layer on an object, and capturing an actual printing trajectory of the first base printing layer. The method further comprises determining printing inkjet data of a first color layer based on the actual printing trajectory of the first base printing layer and printing the first color layer on the first base printing layer based on the printing inkjet data of the first color layer to obtain an additive printed object. The method further comprises setting the additive printed object as a new object to be printed, and repeatedly performing the printing step, the capturing step, the determining step, and printing step, until the three-dimensional printed object is obtained.

### CROSS-REFERENCE TO RELATED APPLICATION

The present disclosure claims priority of the Chinese Patent Application No. 202311871885.8, filed on Dec. 29, 2023 before the China National Intellectual Property Administration, entitled “Three-dimensional printed object, method for printing three-dimensional printed object, and three-dimensional printer.” The content of the above application is incorporated herein by reference in its entirety.

### FIELD

The present disclosure is applied to the technical field of three-dimensional printing, and particularly relates to a three-dimensional printed object, a method for printing a three-dimensional printed object, and a three-dimensional printer.

### BACKGROUND

Three-dimensional printing technology is an additive manufacturing technology. With the development of three-dimensional printing technology, the continuous maturation of three-dimensional printing technology has propelled significant leaps in related manufacturing industries.

Currently, the three-dimensional printing technology often involves the printing of a three-dimensional printed object by alternately printing a base printing layer and a color layer in sequence, in order to consider both the shape and the color of the three-dimensional printed object.

However, when the base printing layer is printed, due to an error in motion, shrinkage of material and other factors, there may be a deviation between a dimension of a base printing layer final printed and a designed dimension of the base printing layer. Such a deviation may cause one or more color layers to misalign with the corresponding base printing layer, thereby resulting in a significant color printing error in the three-dimensional printed object.

### SUMMARY

The present disclosure describes a three-dimensional printed object, a method for printing a three-dimensional printed object, and a three-dimensional printer, to solve a problem of a color printing error in the three-dimensional printed object.

In order to solve the technical problem described above, the present disclosure provides a method for printing a three-dimensional printed object. The method comprises: printing a first base printing layer on an object, and capturing an actual printing trajectory of the first base printing layer; determining printing inkjet data of a first color layer based on the actual printing trajectory of the first base printing layer; printing the first color layer on the first base printing layer based on the printing inkjet data of the first color layer to obtain an additive printed object; setting the additive printed object as a new object, and repeatedly performing the printing, the capturing, the determining, and the printing steps until the three-dimensional printed object is obtained.

In some examples, the step of printing the first base printing layer on the object and capturing the actual printing trajectory of the first base printing layer comprises: obtaining a theoretical printing trajectory of the first base printing layer, and dividing the theoretical printing trajectory to generate a plurality of consecutive trajectory instructions; sequentially executing a plurality of the consecutive trajectory instructions to continuously print the first base printing layer on the object to be printed; and capturing in real time a plurality of printing trajectory points of the first base printing layer in response to executing a plurality of the consecutive trajectory instructions, and determining a target trajectory instruction corresponding to each of the printing trajectory points, and determining a plurality of the printing trajectory points as the actual printing trajectory of the first base printing layer.

In some examples, the step of dividing the theoretical printing trajectory to generate a plurality of the consecutive trajectory instructions comprises dividing the theoretical printing trajectory to generate a plurality of outer wall trajectory instructions, a plurality of inner wall trajectory instructions, and a plurality of filling trajectory instructions that are consecutive. The step of sequentially executing a plurality of the consecutive trajectory instructions to continuously print the first base printing layer on the object to be printed comprises a step of executing each of the outer wall trajectory instructions, each of the inner wall trajectory instructions, and each of the filling trajectory instructions separately, until an outer wall layer, an inner wall layer, and a filling layer are generated on the object, to obtain the first base printing layer. The step of capturing in real time a plurality of the printing trajectory points of the first base printing layer in responses to executing a plurality of the trajectory instructions, and determining a target trajectory instruction corresponding to each of the printing trajectory points comprises a step of capturing in real time a plurality of printing trajectory points of the outer wall layer in response to executing the outer wall trajectory instructions, and determining a target trajectory instruction corresponding to each of the printing trajectory points in the outer wall trajectory instructions.

In some examples, the step of dividing the theoretical printing trajectory to generate a plurality of the outer wall trajectory instructions, a plurality of the inner wall trajectory instructions, and a plurality of the filling trajectory instructions that are consecutive comprises: setting a capture start identifier in a first outer wall trajectory instruction and a capture stop identifier in a final outer wall trajectory instruction in a plurality of the outer wall trajectory instructions that are consecutive. The step of capturing in real time a plurality of the printing trajectory points of the outer wall layer in response to executing a plurality of the outer wall trajectory instructions, and determining the target trajectory instruction corresponding to each of the printing trajectory points in the outer wall trajectory instructions comprises: in response to presence of the capture start identifier in an outer wall trajectory instruction currently executed, capturing in real time the printing trajectory points of the outer wall layer based on a preset rule until presence of the capture stop identifier in an outer wall trajectory instruction currently executed, to obtain a plurality of the printing trajectory points and determine the target trajectory instruction corresponding to each of the printing trajectory points.

In some examples, the step of dividing the theoretical printing trajectory to generate a plurality of the outer wall trajectory instructions, a plurality of the inner wall trajectory instructions, and a plurality of the filling trajectory instructions that are consecutive further comprises a step of sorting a plurality of the outer wall trajectory instructions that are consecutive, and sequentially setting sequence number identifiers in a plurality of the sorted outer wall trajectory instructions. The step of capturing in real time a plurality of the printing trajectory points of the outer wall layer in response to executing a plurality of the outer wall trajectory instructions, and determining the target trajectory instruction corresponding to each of the printing trajectory points in the outer wall trajectory instructions further comprises steps of: capturing in real time a plurality of the printing trajectory points of the outer wall layer, and obtaining a sequence number range of the outer wall trajectory instructions corresponding to each of the printing trajectory points; determining a theoretical point closest to the printing trajectory point in a theoretical printing trajectory corresponding to a plurality of the outer wall trajectory instructions within the sequence number range; and determining an outer wall trajectory instruction corresponding to the theoretical point closest to the printing trajectory point as the target trajectory instruction corresponding to the printing trajectory point.

In some examples, the step of capturing in real time the printing trajectory points of the outer wall layer based on the preset rule comprises a step of: capturing in real time a plurality of the printing trajectory points of the outer wall layer based on a preset frequency; or capturing a current initial trajectory point of the outer wall layer based on a preset frequency; in response to a distance between the current initial trajectory point and a previous initial trajectory point greater than or equal to a preset distance, determining the current initial trajectory point as the printing trajectory point; in response to the distance between the current initial trajectory point and the previous initial trajectory point smaller than the preset distance, re-capturing a new current initial trajectory point of the outer wall layer based on the preset frequency until a current initial trajectory point having a distance from a new previous initial trajectory point greater than or equal to the preset distance is obtained, and determining the new current initial trajectory point as the printing trajectory point; or dividing a consecutive moving distance corresponding to a plurality of the outer wall trajectory instructions uniformly to obtain a plurality of set distances, and determining an outer wall trajectory instruction corresponding to a divided end point of each of the set distances as a captured trajectory instruction; and capturing in real time a plurality of the printing trajectory points of the outer wall layer based on transmission of the captured trajectory instruction.

In some examples, the determining the printing inkjet data of the first color layer based on the actual printing trajectory of the first base printing layer comprises: determining a color of the theoretical point closest to the printing trajectory point in the target trajectory instruction corresponding to each of the printing trajectory points as a color of each of the corresponding printing trajectory point; extending each of the printing trajectory points along the first color layer in a normal direction towards an interior of the three-dimensional printed object based on a ring width of the first color layer, to obtain a plurality of line segments that meet the ring width; and setting a color of each of the line segments to the color of the corresponding printing trajectory point to obtain the printing inkjet data of the first color layer.

In some examples, the step of setting the color of each of the line segments to the color of the corresponding printing trajectory point to obtain the printing inkjet data of the first color layer comprises steps of: in response to intersection of two adjacent line segments in a plurality of the line segments and different colors of printing trajectory points corresponding to the two adjacent line segments, performing interpolation approximation on the colors of the printing trajectory points corresponding to the two adjacent line segments to obtain a blended color; and determining a color of an intersecting part of the two adjacent line segments as the blended color.

In order to solve the technical problem described above, the present disclosure further provides a three-dimensional printed object. The three-dimensional printed object includes a base printing layer and a color layer that are stacked alternately in sequence. The three-dimensional printed object is manufactured (e.g., made, generated) by the method for printing the three-dimensional printed object described herein.

In order to solve the technical problem described above, the present disclosure further provides a three-dimensional printer for performing the method for printing the three-dimensional printed object according to any one of the items described above. The three-dimensional printer comprises: a planning mechanism configured to plan a theoretical printing trajectory of a base printing layer and determine printing inkjet data of a color layer; a control mechanism connected to the planning mechanism and configured to control an execution mechanism to perform printing based on the theoretical printing trajectory of the base printing layer and the printing inkjet data of the color layer; and the execution mechanism connected to the control mechanism and configured to perform printing, in which the execution mechanism is provided with a displacement sensor configured to capture an actual printing trajectory of the base printing layer and transmit the actual printing trajectory to the planning mechanism, to enable the planning mechanism to determine the printing inkjet data of the color layer based on the actual printing trajectory of the base printing layer.

In order to solve the technical problem described above, the method for printing a three-dimensional printed object of the present disclosure comprises: obtaining an object, printing a first base printing layer on the object, and capturing an actual printing trajectory of the first base printing layer; determining printing inkjet data of a first color layer based on the actual printing trajectory of the first base printing layer; printing the first color layer on a side of the first base printing layer away from the object to be printed based on the printing inkjet data of the first color layer to obtain an additive printed object; setting the additive printed object as a new object to be printed, and repeatedly performing the step of printing the first base printing layer on the object to be printed and capturing the actual printing trajectory of the first base printing layer and the subsequent steps, until the three-dimensional printed object is obtained. Therefore, through determining the printing inkjet data of the first color layer based on the actual printing trajectory of the first base printing layer, an error in precision of the printing dimensions can be eliminated, so that the printing inkjet data of the first color layer can be aligned with the actual printing trajectory of the first base printing layer, thereby reducing the color printing error. Specifically, ink can be reduced from being mis-jetted and falling onto an outer surface of an underlying layer, or ink can be reduced from falling onto a place far from an outer edge of an upper surface of an outer wall, thereby ensuring printing precision and accuracy of the color layer and enhancing color accuracy of the three-dimensional printed object.

### BRIEF DESCRIPTION OF THE DRAWINGS

FIG. 1 is a flowchart illustrating a method for printing a three-dimensional printed object according to an example of the present disclosure;

FIG. 2 is a flowchart illustrating a method for printing a three-dimensional printed object according to another example of the present disclosure;

FIG. 3 is a schematic cross-sectional structural diagram of a base printing layer according to an example of the present disclosure;

FIG. 4 is a schematic cross-sectional structural diagram of a three-dimensional printed object according to an example of the present disclosure; and

FIG. 5 is a schematic structural diagram of a three-dimensional printer according to an example of the present disclosure.

### DETAILED DESCRIPTION

The technical solutions in the present disclosure will be clearly and completely described below in conjunction with the accompanying drawings in the present disclosure. The examples described herein are only part of, rather than all of examples of the present disclosure. On the basis of the examples in the present disclosure, all other examples obtained by a person skilled in the art without creative labor shall fall within the protection scope of the present disclosure.

It should be noted that if the examples of the present disclosure involve directional indications (such as up, down, left, right, front, back, etc.), the directional indications are merely used to explain the relative positions and movements of various components in a specific orientation (as shown in the accompanying drawings), and if the specific orientation is changed, the directional indications are also changed accordingly.

Further, if the examples of the present disclosure involve descriptions such as “first”, “second”, etc., such descriptions are merely used for the purpose of description and should not be understood as indicating or implying their relative importance or implicitly suggesting the quantity of the technical features to which they refer. Therefore, features defined by the terms “first” and “second” may explicitly or implicitly include at least one of the features. In addition, combinations can be performed on the technical solutions according to various examples of the present disclosure, but these combinations must be based on the fact that they can be realized by those skilled in the art. When a combination of the technical solutions is contradictory or unattainable, the combination of the technical solutions neither exists nor falls within the protection scope of the appended claims of the present disclosure.

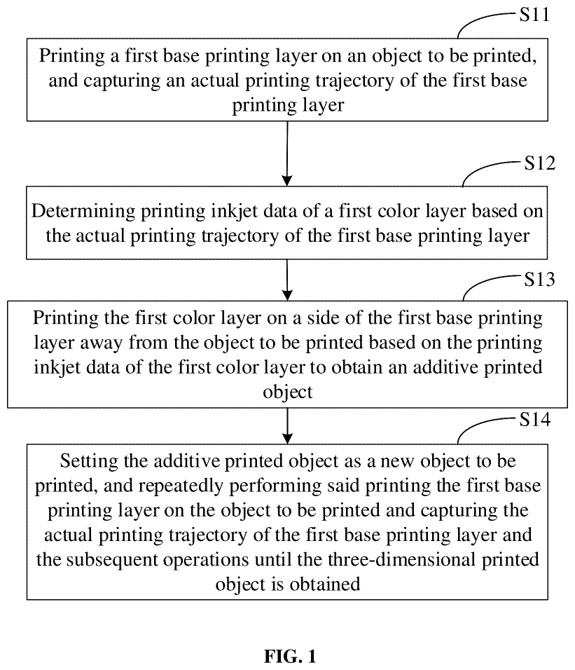

Referring to FIG. 1, FIG. 1 is a schematic flowchart of a method for printing a three-dimensional object according to an example of the present disclosure. The method may be performed by a computing device such as a three-dimensional printer (e.g., 3D printer).

At step S11, printing is performed on an object to be printed to obtain a first base printing layer, and an actual printing trajectory of the first base printing layer is determined (e.g., captured). For example, a computing device prints (e.g., generates, produces) a first base printing layer is determined for an object and determines an actual printing trajectory of the first base printing layer.

The object to be printed includes a print bed of a three-dimensional printer and an unfinished three-dimensional printed object during a printing process. In a specific application scenario, when initiating printing of a three-dimensional printed object, the print bed of the three-dimensional printer may be determined as the object to be printed. The printing may be performed on the print bed of the three-dimensional printer to obtain the first base printing layer first, and then a subsequent preparation and/or action may be performed. In a specific application scenario, when the three-dimensional printed object is in an intermediate printing process, the unfinished three-dimensional printed object may be determined as the object to be printed. The printing may be performed on the unfinished three-dimensional printed object to obtain the first base printing layer first, and then the subsequent preparation may be performed. The determination of the object to be printed is set based on the specific flow of the printing, which is not limited herein.

The first base printing layer is a base printing layer currently being printed on the object to be printed. When the printing of the current first base printing layer is completed and a next base printing layer needs to be printed, the next base printing layer is the second base printing layer, and the third base printing layer and the fourth base printing layer are printed in sequence and analogously, which will not be elaborated herein.

After the object to be printed is determined, the printing is performed on the object to be printed to obtain the first base printing layer. In a specific application scenario, the printing of the first base printing layer may be performed by a fused deposition modeling (FDM) technology. In a specific application scenario, the printing of the first base printing layer may also be performed by a printing technology such as a resin three-dimensional printing technology, a powder bed fusion printing technology, a material jet (M-Jet) printing technology, a plastic free forming (APF) printing technology, and the like, which is not limited herein.

The actual printing trajectory of the first base printing layer is captured during the printing process of the first base printing layer. In a specific application scenario, a sensor (e.g., displacement sensor) may be provided on an execution mechanism of the three-dimensional printer, so that a displacement of the execution mechanism is sensed in real time by the displacement sensor. Since the printing of the base printing layer is specifically performed by the execution mechanism, the actual printing trajectory of the first base printing layer may be obtained by sensing the displacement of the execution mechanism. In a specific application scenario, an image recognition unit (e.g., a camera, an imaging device) may be provided on the three-dimensional printer or is part of the three-dimensional printer. After the first base printing layer is printed, the actual printing trajectory of the first base printing layer is obtained through by the image recognition unit (e.g., by capturing one or more images and/or videos and performing image and video recognition). The method for obtaining the actual printing trajectory is not limited herein.

At step S12, printing inkjet data of a first color layer is determined based on the actual printing trajectory of the first base printing layer.

When determining the printing inkjet data of the first color layer, the actual printing trajectory of the first base printing layer is considered instead of referring to the theoretical printing trajectory of the first base printing layer. Therefore, through the actual printing trajectory of the first base printing layer, an error in precision of the printing dimension can be eliminated, so that the printing inkjet data of the first color layer can be aligned with the actual printing trajectory of the first base printing layer, thereby ensuring printing precision of the color layer.

The first color layer is a color layer currently being printed on the first base printing layer. When the printing of the current first color layer is completed and a second base printing layer needs to be printed, a second color printing layer is printed on the second base printing layer, and the third color printing layer and the fourth color printing layer are printed in sequence and analogously, which will not be elaborated herein.

At step S13, the first color layer is printed on the first base printing layer (e.g., a top surface of the first base printing layer) based on the printing inkjet data of the first color layer to obtain an additive printed object.

In a specific application scenario, the first color layer may be printed on the first base printing layer based on the printing inkjet data of the first color layer through a full-color inkjet photopolymerization three-dimensional printing technology. In a specific application scenario, the printing of the first color layer may also be performed by using a thermosetting ink printing technology, curing agent ink printing technology, or other chemically cured ink printing technologies.

After the printing of the first color layer is completed, the base printing layer and the first color layer may be added to the object to be printed, and the additive printed object is obtained.

At step S14, the additive printed object is set as a new object to be printed, and the step of printing the first base printing layer on the object to be printed and capturing the actual printing trajectory of the first base printing layer and the subsequent steps are repeatedly performed, until the three-dimensional printed object is obtained.

In a specific application scenario, when it may be still necessary to continue printing after adding the base printing layer and the first color layer on the object to be printed, the additive printed object is set as the new object to be printed, and the above steps S11 to S13 are executed repeatedly until the layers are added to obtain the three-dimensional printed object.

In a specific application scenario, when the printing is completed after adding the base printing layer and the first color layer on the object to be printed, the additive printed object is determined as the three-dimensional printed object, and the printing is finished.

Through the above steps of the method for printing the three-dimensional printed object provided by this example, the object to be printed is obtained, the first base printing layer is printed on the object to be printed, and the actual printing trajectory of the first base printing layer is captured. The printing inkjet data of the first color layer is determined based on the actual printing trajectory of the first base printing layer. The first color layer is printed on the side of the first base printing layer away from the object to be printed based on the printing inkjet data of the first color layer to obtain the additive printed object. The additive printed object is set as the new object to be printed, and the step of printing the first base printing layer on the object to be printed and capturing the actual printing trajectory of the first base printing layer and the subsequent steps are repeatedly performed until the three-dimensional printed object is obtained.

Therefore, through determining the printing inkjet data of the first color layer based on the actual printing trajectory of the first base printing layer, an error in precision of the printing dimension can be eliminated, so that the printing inkjet data of the first color layer can be aligned with the actual printing trajectory of the first base printing layer, thereby reducing color printing errors. Specifically, it can reduce an occurrence of ink misprints falling onto an outer surface of an underlying layer, or ink droplets landing too far from an outer edge of an outer wall's upper surface, thereby ensuring printing precision and accuracy of the color layer and enhancing color accuracy of the three-dimensional printed object.

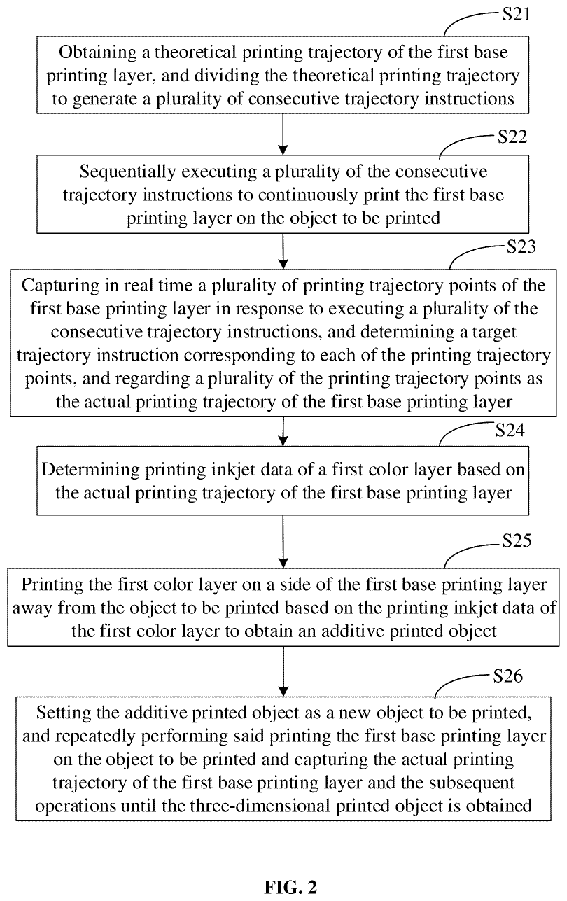

Referring to FIG. 2, FIG. 2 is a flowchart illustrating a method for printing a three-dimensional printed object according to another example of the present disclosure.

At step S21, a theoretical printing trajectory of a first base printing layer is obtained, and the theoretical printing trajectory is divided to generate a plurality of consecutive trajectory instructions.

Before starting the printing (e.g., before step S21), a displacement sensor may be provided on the execution mechanism of the three-dimensional printer. The displacement sensor may be part of the three-dimensional printer. The displacement sensor may be a sensor that directly measures the linear displacement of an object. The displacement sensor includes, but not limited to, a grating ruler, a magnetic grating ruler, a grating encoder, a grating code disk, a magnetic grating encoder, and/or a magnetic grating code disk.

During the printing process, the printing is performed on the object to be printed by the execution mechanism of the three-dimensional printer to obtain the first base printing layer. A plurality of printing trajectory points of an outer wall layer are captured in real time by the displacement sensor, and a plurality of the printing trajectory points are determined as an actual printing trajectory of the first base printing layer. The outer wall layer may be associated with the first base printing layer. For example, the outer wall layer may be an outer wall of the first base printing layer. The first base printing layer may comprise an outer wall layer, an inner wall layer, and a filling layer. The number of the printing trajectory points may be set on the basis of experience or may be set on the basis of a capture frequency of the displacement sensor, which is not limited herein.

During printing, the printing is performed on the object to be printed to obtain the first base printing layer, and the actual printing trajectory of the first base printing layer is captured.

In a specific application scenario, a specific printing process of the first base printing layer is that the theoretical printing trajectory of the first base printing layer is obtained, and the theoretical printing trajectory is divided to generate a plurality of the consecutive trajectory instructions. The theoretical printing trajectory of the first base printing layer may be obtained by slicing a model of the three-dimensional printed object with slicing software. After obtaining the theoretical printing trajectory of the first base printing layer, when printing by the three-dimensional printer, it is necessary to convert the theoretical printing trajectory into a trajectory instruction recognizable by the three-dimensional printer, so that the three-dimensional printer may execute the trajectory instruction to perform the printing based on the theoretical printing trajectory. The slicing software may be computer-aided manufacturing software for three-dimensional printing, which cuts a three-dimensional model into many planes or curved surfaces stacked together according to the single-layer printing thickness of the three-dimensional printer, so as to obtain the theoretical printing trajectory.

In a specific application scenario, the trajectory instruction may be a Gcode instruction or other logical instruction. Gcode is a standardized computer numerical control programming language for controlling a mechanical device. The model of the three-dimensional printed object is sliced and converted by the slicing software, and a text file containing a plurality of Gcode trajectory instructions is generated, so that the three-dimensional printer may perform the printing based on the text file. The trajectory instruction includes, but is not limited to, data information such as a printing speed, acceleration, and a theoretical printing trajectory.

In a specific application scenario, the printing of the base printing layer may be divided into printing of an outer wall layer, printing of an inner wall layer, and printing of a filling layer separately, and the base printing layer is formed by combining the outer wall layer, the inner wall layer, and the filling layer.

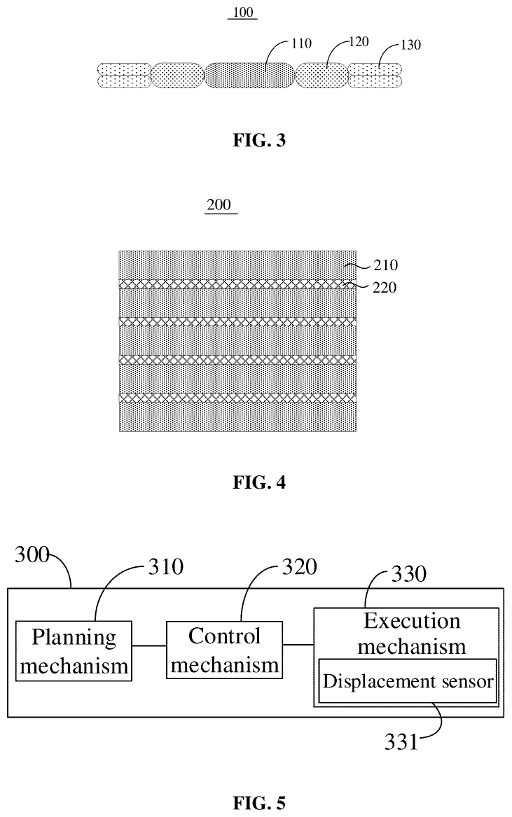

Referring to FIG. 3, FIG. 3 is a schematic cross-sectional structural diagram of a base printing layer according to an example.

A base printing layer 100 of the example includes an outer wall layer 130, an inner wall layer 120, and a filling layer 110. The inner wall layer 120 is disposed in a fitting manner around the filling layer 110, and the outer wall layer 130 is disposed in a fitting manner around the inner wall layer 120. The outer wall layer 130 and the inner wall layer 120 may collectively construct an overall outer shape of the base printing layer 100, and the filling layer 110 may fill the outer shape to improve structural stability.

In response to generating a plurality of the consecutive trajectory instructions, the theoretical printing trajectory may be divided to generate a plurality of outer wall trajectory instructions, a plurality of inner wall trajectory instructions, and a plurality of filling trajectory instructions that are consecutive. Each of the outer wall trajectory instructions, each of the inner wall trajectory instructions, and each of the filling trajectory instructions may be executed separately by the execution mechanism of the three-dimensional printer, until an outer wall layer, an inner wall layer, and a filling layer are generated on the object to be printed, to obtain the first base printing layer.

No other motion instructions, such as a non-printing move instruction, a retraction instruction, a backfill instruction, and other instructions may be inserted into a plurality of the outer wall trajectory instructions to ensure the consecutiveness of a plurality of the outer wall trajectory instructions.

Since the color layer is used to display an appearance color of the three-dimensional printed object, the color layer primarily needs to be flush with an outer wall of the first base printing layer, thereby displaying a corresponding color on the outer wall layer. Therefore, the determination of the actual printing trajectory of the first base printing layer in this example may be primarily to determine the actual printing trajectory of the outer wall layer of the first base printing layer.

In a specific application scenario, in order to capture the actual printing trajectory of the outer wall layer of the first base printing layer, in response to generating a plurality of the outer wall trajectory instructions, a capture start identifier is set in a first outer wall trajectory instruction and a capture stop identifier is set in a final outer wall trajectory instruction in a plurality of the outer wall trajectory instructions that are consecutive. The capture start identifier and the capture stop identifier are respectively used to control the start and the end of trajectory capture. The capture start identifier and the capture stop identifier are respectively set in the first outer wall trajectory instruction and the final outer wall trajectory instruction in a plurality of the outer wall trajectory instructions that are consecutive, so that the actual printing trajectory of the outer wall layer of the first base printing layer can be captured.

In a specific application scenario, in order to capture the actual printing trajectory of the outer wall layer of the first base printing layer, in response to generating a plurality of the outer wall trajectory instructions, a marker parameter may be further set in each of the outer wall trajectory instructions to distinguish the outer wall trajectory instruction from other trajectory instructions through the marker parameter.

At step S22, a plurality of the consecutive trajectory instructions are sequentially executed to continuously print the first base printing layer on the object to be printed.

The execution mechanism may include a transverse and longitudinal movement device and a printing nozzle, to move to a target position by using the transverse and longitudinal movement device based on a trajectory instruction of a plurality of the consecutive trajectory instructions, and then to perform the printing at the target position by using the printing nozzle, thereby sequentially executing a plurality of the consecutive trajectory instructions to continuously print the first base printing layer on the object to be printed.

In a specific application scenario, each of the outer wall trajectory instructions, each of the inner wall trajectory instructions, and each of the filling trajectory instructions are executed separately by the execution mechanism of the three-dimensional printer, until the outer wall layer, the inner wall layer, and the filling layer are generated on the object to be printed, to obtain the first base printing layer.

At step S23, a plurality of printing trajectory points of the first base printing layer in response to executing a plurality of the consecutive trajectory instructions are captured in real time, a target trajectory instruction corresponding to each of the printing trajectory points is determined, and a plurality of the printing trajectory points are determined as the actual printing trajectory of the first base printing layer.

Step S23 and step S22 are not sequential, and may be performed simultaneously.

A plurality of the printing trajectory points in response to executing the trajectory instructions by the execution mechanism may be captured in real time by the displacement sensor, and the target trajectory instruction corresponding to each of the printing trajectory points is determined. A plurality of the printing trajectory points is determined as the actual printing trajectory of the first base printing layer. In an example, a plurality of the printing trajectory points in response to executing the trajectory instructions by the execution mechanism may be captured in real time, and the target trajectory instruction corresponding to each of the printing trajectory points in the outer wall trajectory instruction can be determined. A plurality of the printing trajectory points is determined as the actual printing trajectory of the outer wall of the first base printing layer.

In a specific application scenario, the capture start identifier is set in the first outer wall trajectory instruction and the capture stop identifier is set in the final outer wall trajectory instruction in a plurality of the outer wall trajectory instructions that are consecutive. During the printing process of the first base printing layer, in response to a presence of the capture start identifier in an outer wall trajectory instruction currently executed, printing trajectory points of the outer wall layer may be captured in real time based on a preset rule until a presence of the capture stop identifier in another outer wall trajectory instruction currently executed, to obtain a plurality of the printing trajectory points and determine the target trajectory instruction corresponding to each of the printing trajectory points. For example, in response to the presence of the capture start identifier in the outer wall trajectory instruction currently executed, a current position of the displacement sensor is determined as a first printing trajectory point of the actual printing trajectory. Subsequent outer wall trajectory instructions are sequentially executed, and printing trajectory points of the execution mechanism are captured in real time by the displacement sensor until the presence of the capture stop identifier in the other outer wall trajectory instruction currently executed. Another current position of the displacement sensor is determined as a final printing trajectory point of the actual printing trajectory. A plurality of the printing trajectory points are obtained, and the target trajectory instruction corresponding to each of the printing trajectory points in a plurality of the outer wall trajectory instructions is determined.

In a specific application scenario, the marker parameter is set in each of the outer wall trajectory instructions. During the printing process of the first base printing layer, in response to the presence of the marker parameter in a trajectory instruction currently executed, the trajectory instruction currently executed is determined as an outer wall trajectory instruction. Then, the printing trajectory point of the execution mechanism is captured in real time by the displacement sensor, and the target trajectory instruction corresponding to each of the printing trajectory points in a plurality of the outer wall trajectory instructions is determined.

A plurality of the printing trajectory points may be determined as the actual printing trajectory of the outer wall of the first base printing layer. In response to an initiation of printing of the whole three-dimensional printed object, the displacement sensor is first zeroed to determine an absolute zero value of the displacement sensor in this printing, thereby enhancing positional accuracy of the displacement sensor in capturing printing trajectory points of each layer. When changing a layer during the printing of the base printing layer, the displacement sensor may not re-zeroed.

When determining the target trajectory instruction corresponding to each of the printing trajectory points, a certain time lag exists when the three-dimensional printer obtains the trajectory instructions and executes the trajectory instructions to perform the printing, which may lead to a certain error in establishing a correspondence between the printing trajectory point and the target trajectory instruction. Therefore, in order to establish a correct correspondence between the printing trajectory point and the target trajectory instruction, according to this example, when generating a plurality of consecutive outer wall trajectory instructions, a plurality of the outer wall trajectory instructions that are consecutive may be sorted, and sequence number identifiers may be sequentially set in a plurality of the sorted outer wall trajectory instructions. For example, when 100 consecutive outer wall trajectory instructions exist, the 100 consecutive outer wall trajectory instructions may be sequentially and respectively set with sequence number identifiers of “1, 2, 3, 4, 5 . . . 99, and 100” in an order of arrangement of the 100 outer wall trajectory instructions.

During the printing process of the first base printing layer, a plurality of the printing trajectory points of the outer wall layer may be captured in real time by the displacement sensor, and a sequence number range of a plurality of outer wall trajectory instructions corresponding to each of the printing trajectory points may be obtained. The specific extent of the sequence number range may be set based on the specific time lag between obtaining the trajectory instructions and executing the trajectory instructions by the three-dimensional printer. For example, for a three-dimensional printer with a small time lag, a smaller sequence number range can be used; for a three-dimensional printer with a large time lag, a larger sequence number range can be used.

A theoretical point closest to the printing trajectory point may be determined in a theoretical printing trajectory corresponding to a plurality of the outer wall trajectory instructions within the sequence number range; and an outer wall trajectory instruction corresponding to the theoretical point closest to the printing trajectory point may be determined as the target trajectory instruction corresponding to the printing trajectory point.

In a specific application scenario, a certain printing trajectory point (x1, y1) of the execution mechanism is first captured in real time by the displacement sensor, and a sequence number range of outer wall trajectory instructions corresponding to the printing trajectory point (x1, y1) is obtained, assuming that the sequence number range ranges from 12 to 15. A theoretical point (x2, y2) closest to the printing trajectory point is determined within the theoretical printing trajectory corresponding to the 12th outer wall trajectory instruction to the 15th outer wall trajectory instruction. When the sequence number of the outer wall trajectory instruction corresponding to the theoretical point (x2, y2) is 13, the target trajectory instruction corresponding to the printing trajectory point (x1, y1) is determined as the 13th outer wall trajectory instruction.

According to this example, by marking the outer wall trajectory instructions with sequence numbers and combining them with distance measurements to doubly determine the target trajectory instruction corresponding to each of the printing trajectory points, the accuracy of the correspondence between the printing trajectory point and the target trajectory instruction can be improved.

In a specific application scenario, capturing in real time by the displacement sensor the printing trajectory points of the execution mechanism based on the preset rule includes: capturing in real time by the displacement sensor a plurality of the printing trajectory points of the outer wall layer based on a preset frequency. The preset frequency may be set based on actual needs, for example, 10 times/second, 5 times/second, 20 times/second, etc., which is not limited herein. By initiating a hardware timer with a fixed period, the readings of the displacement sensor may be read regularly based on the preset frequency, and then the printing trajectory points may be captured in real time.

In a specific application scenario, said capturing in real time the printing trajectory points of the execution mechanism based on the preset rule may include: capturing a current initial trajectory point of the outer wall layer based on a preset frequency; in response to a distance between the current initial trajectory point and a previous initial trajectory point being greater than or equal to a preset distance, determining the current initial trajectory point as the printing trajectory point. In response to the distance between the current initial trajectory point and the previous initial trajectory point being smaller than the preset distance, re-capturing a new current initial trajectory point of the outer wall layer based on the preset frequency until a new current initial trajectory point having a distance greater than or equal to the preset distance from a new previous initial trajectory point is obtained, and determining the new current initial trajectory point as the printing trajectory point. The preset distance may be used to divide the distance between the printing trajectory points. When the distance between two adjacent initial trajectory points is smaller than the preset distance, it indicates that the distance between the two initial trajectory points is very close, making it difficult to reflect different amounts of information on the actual printing trajectory. Therefore, the current initial trajectory point in the two initial trajectory points is not adopted, in order to reduce data complexity while ensuring the actual printing trajectory. In a specific application scenario, a high-frequency hardware timer with a fixed period may be initiated to read readings of the displacement sensor regularly based on the preset frequency. And a displacement difference between a current reading of the displacement sensor and a reading of the displacement sensor recorded last time is calculated. When the difference is greater than or equal to the preset distance, the current reading of the displacement sensor and the current time are saved to obtain the printing trajectory point, and the compared reading of the displacement sensor is refreshed.

In a specific application scenario, said capturing in real time the printing trajectory points of the execution mechanism based on the preset rule may include: dividing a consecutive moving distance corresponding to a plurality of the outer wall trajectory instructions uniformly to obtain a plurality of set distances, and determining an outer wall trajectory instruction corresponding to a divided end point of each of the set distances as a captured trajectory instruction; and capturing in real time a plurality of the printing trajectory points of the outer wall layer based on a transmission of the captured trajectory instruction. Since a displacement of an outer wall trajectory instruction may be determined based on the outer wall trajectory instruction, the moving distance corresponding to a plurality of the outer wall trajectory instructions may be divided directly to obtain a plurality of the set distances before printing, thereby printing trajectory points under outer wall trajectory instructions corresponding to each of plurality of set distances may be captured directly.

By using the capturing methods described above, the contribution of each printing trajectory point to the actual printing trajectory can be improved, thereby improving the accuracy of the actual printing trajectory.

In a specific application scenario, after obtaining a plurality of the printing trajectory points of the outer wall, a plurality of the printing trajectory points may further be smoothed and fitted to remove a printing trajectory point that is greatly different from other printing trajectory points, so as to reduce the influence of some errors during the capture process on the actual printing trajectory.

At step S24, printing inkjet data of a first color layer is determined based on the actual printing trajectory of the first base printing layer.

A color of the theoretical point closest to each of the printing trajectory points in the target trajectory instruction corresponding to each of the printing trajectory points is determined as a color of the printing trajectory point. Each of the printing trajectory points is extended along the first color layer in a normal direction towards an interior of the three-dimensional printed object based on a ring width of the first color layer, to obtain a plurality of line segments that meet the ring width. A color of each of the line segments is set to the color of the printing trajectory point corresponding to the line segment to obtain the printing inkjet data of the first color layer.

A path of the printing trajectory of the first color layer is determined based on positions of the printing trajectory points, and a color of the printing trajectory of the first color layer is determined based on the color of the theoretical point closest to each of the printing trajectory points.

In a specific application scenario, each of the printing trajectory points is extended along the first color layer in a normal direction towards an interior of the three-dimensional printed object based on a ring width of the first color layer, to obtain a plurality of line segments that meet the ring width; and a color of each of the line segments is set to the color of the printing trajectory point corresponding to the line segment to obtain the printing inkjet data of the first color layer.

Since the color layer is mainly used to display the appearance color of the three-dimensional printed object, only an outer ring of the color layer may be colored, and an inner ring of the color layer may be transparent or white, so as to save the usage of full-color ink and reduce costs. Therefore, after a plurality of the printing trajectory points of the printing trajectory and colors corresponding to a plurality of the printing trajectory points are determined, each of the printing trajectory points is extended along the first color layer in the normal direction towards the interior of the three-dimensional printed object to obtain a plurality of the line segments satisfying the ring width. The color of the entire line segment is the same as the color of the printing trajectory point corresponding to the line segment. The ring width may be specifically set based on actual needs, for example, 2 mm, 3 mm, 4 mm, and the like, which is not limited herein.

In a specific application scenario, in response to an intersection of two adjacent line segments of a plurality of the line segments and colors of printing trajectory points corresponding to the two adjacent line segments of a plurality of the line segments being different, interpolation approximation is performed on the colors of the printing trajectory points corresponding to the two adjacent line segments of a plurality of the line segments to obtain a blended color; and a color of an intersecting part of the two adjacent line segments of a plurality of the line segments is determined as the blended color.

Affected by the shape of the three-dimensional printed object, in response to the intersection of two adjacent line segments and the colors of printing trajectory points corresponding to the two adjacent line segments being different, the color of the intersecting part may be obtained by blending the colors of the two adjacent line segments through the interpolation approximation. It can be ensured that the color of the intersecting part matches with the colors of the two adjacent line segments at the same time, and the width of the outer wall of the color layer can be guaranteed. The color can be displayed through a transmission method to ensure the saturation of the color display.

In a specific application scenario, when the distance between inner loop points of two adjacent line segments of a plurality of the line segments is too small, the inner loop points of the two line segments may further be merged to reduce complexity of printing inkjet data of the color layer.

At step S25, the first color layer is printed on a side of the first base printing layer away from the object to be printed based on the printing inkjet data of the first color layer to obtain an additive printed object.

In a specific application scenario, the first color layer may be printed on the side of the first base printing layer away from the object to be printed based on the printing inkjet data of the first color layer through a full-color inkjet photopolymerization three-dimensional printing technology. In a specific application scenario, the printing of the first color layer may also be performed by using a thermosetting ink printing technology, curing agent ink printing technology, or other chemically cured ink printing technologies.

After the printing of the first color layer is completed, the base printing layer and the color layer are added to the object to be printed, and the additive printed object is obtained.

At step S26, the additive printed object is set as a new object to be printed, and the step of printing the first base printing layer on the object to be printed and capturing the actual printing trajectory of the first base printing layer and the subsequent steps are repeatedly performed, until the three-dimensional printed object is obtained.

In a specific application scenario, when it is still necessary to continue printing after adding the base printing layer and the color layer on the object to be printed, the additive printed object is set as the new object to be printed, and the above steps S21 to S25 are executed repeatedly until the layers are added completed to obtain the three-dimensional printed object.

In a specific application scenario, when the printing is completed after adding the base printing layer and the color layer on the object to be printed, the additive printed object is determined as the three-dimensional printed object, and the printing is finished.

Through the steps described above, according to the method for printing the three-dimensional printed object provided by this example, the printing inkjet data of the first color layer is determined based on the actual printing trajectory of the first base printing layer. An error in precision of the printing dimension can be eliminated, so that the printing inkjet data of the first color layer can be aligned with the actual printing trajectory of the first base printing layer, thereby reducing color printing errors, ensuring printing precision and accuracy of the color layer, and enhancing color accuracy of the three-dimensional printed object. And a plurality of the printing trajectory points of the outer wall layer are captured in real time by the displacement sensor to improve the accuracy of the actual printing trajectory.

According to this example, by setting the capture start identifier and the capture stop identifier in the outer wall trajectory instructions, or by setting the marker parameter in each outer wall trajectory instruction to distinguish the outer wall trajectory instruction from other trajectory instructions through the marker parameter, a plurality of the printing trajectory points corresponding to the outer wall trajectory instructions can be accurately determined (e.g., sensed by the displacement sensor), thereby improving the capture accuracy of the actual printing trajectory of the outer wall. In addition, by sequentially setting the sequence number identifiers in a plurality of the sorted outer wall trajectory instructions, in response to capturing the actual printing trajectory of the outer wall, the sequence number range of the outer wall trajectory instructions corresponding to each of the printing trajectory points can be obtained, and then the theoretical point closest to the printing trajectory point is determined in the theoretical printing trajectory corresponding to a plurality of the outer wall trajectory instructions within the sequence number range; and the outer wall trajectory instruction corresponding to the theoretical point closest to the printing trajectory point is determined as the target trajectory instruction corresponding to the printing trajectory point.

The target trajectory instruction corresponding to the printing trajectory point is can be further determined based on the sequence numbers of the outer wall trajectory instructions and the distance, and then the color is determined based on the closest theoretical point of the target trajectory instruction. In this way, the accuracy of the correspondence between the printing trajectory point and the target trajectory instruction can be improved, thereby ensuring printing precision and accuracy of the color layer and enhancing color accuracy of the three-dimensional printed object.

Referring to FIG. 4, FIG. 4 is a schematic cross-sectional structural diagram of a three-dimensional printed object according to an example of the present disclosure. The structure according to this example is merely schematic and not limited. In actual printing, the three-dimensional printed object may have a structure of any shape.

A three-dimensional printed object 200 of this example includes a base printing layer 210 and a color layer 220 that are stacked alternately in sequence. The base printing layer 210 is configured to support an entire shape of the three-dimensional printed object 200, and the color layer 220 is configured to transmit (e.g., show) an appearance color of the three-dimensional printed object 200.

The three-dimensional printed object 200 is prepared by the method for printing the three-dimensional printed object according to any one of the examples described above. Therefore, according to this example, the printing trajectory of the color layer 220 of the three-dimensional printed object 200 may be aligned with the actual printing trajectory of the base printing layer 210, thereby reducing color printing errors. Specifically, it can reduce an occurrence of ink misprints falling onto an outer surface of an underlying layer, or ink droplets landing too far from an outer edge of an outer wall's upper surface, thereby ensuring printing precision and accuracy of the color layer 220 and enhancing color accuracy of the three-dimensional printed object 200.

In some examples, the base printing layer 210 may be a transparent printing layer to transmit the color of the color layer 220, ensuring the appearance color of the three-dimensional printed object 200. The transparency of the base printing layer 210 may be above 70%, and specifically includes, but is not limited to, 70%, 75%, 80%, 85%, 90%, 95%, and 99%, and the like.

Referring to FIG. 5, FIG. 5 is a schematic structural diagram of a three-dimensional printer according to an example of the present disclosure.

According to this example, a three-dimensional printer 300 is configured to perform the method for printing the three-dimensional printed object according to any one of the examples described above. The three-dimensional printer 300 may comprise one or more processors and memory storing instructions, when executed by the one or more processors, cause the three-dimensional printer 300 to perform the methods described herein. The memory may be non-transitory computer-readable media. The three-dimensional printer 300 includes a planning mechanism 310, a control mechanism 320, and an execution mechanism 330. The planning mechanism 310 is configured to plan a theoretical printing trajectory of a base printing layer and determine printing inkjet data of a color layer. The control mechanism 320 is connected to the planning mechanism 310 and configured to control the execution mechanism 330 to perform printing based on the theoretical printing trajectory of the base printing layer and the printing inkjet data of the color layer. The execution mechanism 330 is connected to the control mechanism 320 and configured to perform printing.

The execution mechanism 330 is provided with a displacement sensor 331 configured to capture an actual printing trajectory of the base printing layer and transmit, through the control mechanism 320, the actual printing trajectory of the base printing layer to the planning mechanism 310, to enable the planning mechanism 310 to determine the printing inkjet data of the color layer based on the actual printing trajectory of the base printing layer.

The three-dimensional printer according to this example can print a three-dimensional printed object in which the printing inkjet data of the color layer is aligned with the actual printing trajectory of the base printing layer, thereby reducing color printing errors, ensuring printing precision and accuracy of the color layer, and enhancing color accuracy of the three-dimensional printed object.

Although some examples of the present disclosure are described above, the scope of the present disclosure is not limited to these examples. Within the concept of the present disclosure, any equivalent structure transformation or flow transformation made using the contents of the specification and the accompanying drawings, or any direct or indirect application of the contents of the specification and the accompanying drawings in other related fields, shall equally fall within the scope of the present disclosure.

What is claimed is:

1. A method of printing a three-dimensional object, comprising:
printing a first base printing layer on an object;
capturing an actual printing trajectory of the first base printing layer;
determining printing inkjet data of a first color layer based on the actual printing trajectory of the first base printing layer;
printing the first color layer on the first base printing layer based on the printing inkjet data of the first color layer to obtain an additive printed object; and
setting the additive printed object as a new object, and repeatedly performing the printing, the capturing, the determining, and the printing steps until the three-dimensional object is obtained.

2. The method of printing the three-dimensional object according to claim 1, wherein the printing the first base printing layer comprises:
obtaining a theoretical printing trajectory of the first base printing layer;
generating a plurality of consecutive trajectory instructions based on the theoretical printing trajectory of the first base printing layer; and
sequentially executing a plurality of the consecutive trajectory instructions to continuously print the first base printing layer on the object.

3. The method of printing the three-dimensional object according to claim 2, wherein the capturing comprises:
capturing a plurality of printing trajectory points of the first base printing layer in response to executing the plurality of the consecutive trajectory instructions; and
determining the plurality of the printing trajectory points as the actual printing trajectory of the first base printing layer.

4. The method of printing the three-dimensional object according to claim 2, wherein the generating comprises:
dividing the theoretical printing trajectory to generate a plurality of outer wall trajectory instructions, a plurality of inner wall trajectory instructions, and a plurality of filling trajectory instructions.

5. The method of printing the three-dimensional object according to claim 4, wherein the sequentially executing comprises:
executing each of the plurality of outer wall trajectory instructions, each of the plurality of inner wall trajectory instructions, and each of the plurality of filling trajectory instructions separately, until an outer wall layer, an inner wall layer, and a filling layer are generated, and wherein the method further comprises:
capturing a plurality of printing trajectory points of the outer wall layer in response to executing the outer wall trajectory instructions; and
determining a target trajectory instruction corresponding to each of the plurality of printing trajectory points of the outer wall layer.

6. The method of printing the three-dimensional object according to claim 5, wherein the dividing comprises:
setting a capture start identifier in a first outer wall trajectory instruction and a capture stop identifier in a final outer wall trajectory instruction in the plurality of the outer wall trajectory instructions; and
the capturing the plurality of the printing trajectory points of the outer wall layer comprises:
in response to presence of the capture start identifier in an outer wall trajectory instruction currently executed, capturing the printing trajectory points of the outer wall layer based on a rule until presence of the capture stop identifier in the outer wall trajectory instruction currently executed, to obtain the plurality of the printing trajectory points.

7. The method of printing the three-dimensional object according to claim 5, wherein the dividing comprises:
sorting the plurality of the outer wall trajectory instructions, and sequentially setting sequence number identifiers in the plurality of the sorted plurality of outer wall trajectory instructions; and
the capturing the plurality of the printing trajectory points of the outer wall layer comprises:
obtaining a sequence number range of the outer wall trajectory instructions corresponding to each of the printing trajectory points;
determining a theoretical point closest to the printing trajectory point in a theoretical printing trajectory corresponding to a plurality of the outer wall trajectory instructions within the sequence number range; and
determining an outer wall trajectory instruction corresponding to the theoretical point closest to the printing trajectory point as the target trajectory instruction corresponding to the printing trajectory point.

8. The method of printing the three-dimensional object according to claim 6, wherein the rule comprises:
a fixed frequency; or
a distance associated with a current initial trajectory point and a previous initial trajectory point.

9. The method of printing the three-dimensional object according to claim 7, wherein the determining the printing inkjet data of the first color layer based on the actual printing trajectory of the first base printing layer comprises:
determining a color of the theoretical point closest to the printing trajectory point in the target trajectory instruction corresponding to each of the printing trajectory points as a color of each of the corresponding printing trajectory point;
extending each of the printing trajectory points along the first color layer in a direction towards an interior of the three-dimensional printed object based on a ring width of the first color layer, to obtain a plurality of line segments that meet the ring width; and
setting a color of each of the plurality of line segments to the color of the corresponding printing trajectory point to obtain the printing inkjet data of the first color layer.

10. The method of printing the three-dimensional object according to claim 9, wherein the setting the color comprises:
in response to intersection of two adjacent line segments in the plurality of the line segments and different colors of printing trajectory points corresponding to the two adjacent line segments, performing interpolation approximation on the colors of the printing trajectory points corresponding to the two adjacent line segments to obtain a blended color; and
determining a color of an intersecting part of the two adjacent line segments as the blended color.

11. A three-dimensional printer, comprising:
one or more processors; and
memory storing instructions that, when executed by the one or more processors, cause the three-dimensional printer to:
print a first base printing layer on an object;
capture an actual printing trajectory of the first base printing layer;
determine printing inkjet data of a first color layer based on the actual printing trajectory of the first base printing layer;
print the first color layer on the first base printing layer based on the printing inkjet data of the first color layer to obtain an additive printed object; and
set the additive printed object as a new object, and repeatedly performing printing, capturing, determining, and printing steps until a three-dimensional object is obtained.

12. The three-dimensional printer according to claim 11, wherein the instructions, when executed by the one or more processors, cause the three-dimensional printer to print the first base printing layer by:
obtaining a theoretical printing trajectory of the first base printing layer;
generating a plurality of consecutive trajectory instructions based on the theoretical printing trajectory of the first base printing layer; and
sequentially executing a plurality of the consecutive trajectory instructions to continuously print the first base printing layer on the object.

13. The three-dimensional printer according to claim 12, wherein the instructions, when executed by the one or more processors, cause the three-dimensional printer to capture the actual printing trajectory by:
capturing a plurality of printing trajectory points of the first base printing layer in response to executing the plurality of the consecutive trajectory instructions; and
determining the plurality of the printing trajectory points as the actual printing trajectory of the first base printing layer.

14. The three-dimensional printer according to claim 12, wherein the instructions, when executed by the one or more processors, cause the three-dimensional printer to generate the plurality of consecutive trajectory instructions by:
dividing the theoretical printing trajectory to generate a plurality of outer wall trajectory instructions, a plurality of inner wall trajectory instructions, and a plurality of filling trajectory instructions.

15. The three-dimensional printer according to claim 14, wherein the instructions, when executed by the one or more processors, cause the three-dimensional printer to sequentially execute the plurality of the consecutive trajectory instructions by:
executing each of the outer wall trajectory instructions, each of the inner wall trajectory instructions, and each of the filling trajectory instructions separately, until an outer wall layer, an inner wall layer, and a filling layer are generated, and further cause the three-dimensional printer to:
capture a plurality of printing trajectory points of the outer wall layer in response to executing the outer wall trajectory instructions; and
determine a target trajectory instruction corresponding to each of the plurality of printing trajectory points of the outer wall layer.

16. The three-dimensional printer according to claim 15, wherein the instructions, when executed by the one or more processors, cause the three-dimensional printer to divide the theoretical printing trajectory by:
setting a capture start identifier in a first outer wall trajectory instruction and a capture stop identifier in a final outer wall trajectory instruction in the plurality of the outer wall trajectory instructions; and
cause the three-dimensional printer to capture the plurality of printing trajectory points by:
in response to presence of the capture start identifier in an outer wall trajectory instruction currently executed, capturing the printing trajectory points of the outer wall layer based on a rule until presence of the capture stop identifier in the outer wall trajectory instruction currently executed, to obtain the plurality of the printing trajectory points.

17. One or more non-transitory computer-readable media storing instructions that, when executed, cause:
printing a first base printing layer on an object;
capturing an actual printing trajectory of the first base printing layer;
determining printing inkjet data of a first color layer based on the actual printing trajectory of the first base printing layer;
printing the first color layer on the first base printing layer based on the printing inkjet data of the first color layer to obtain an additive printed object; and
setting the additive printed object as a new object, and repeatedly performing printing, capturing, determining, and printing steps until a three-dimensional object is obtained.

18. The one or more non-transitory computer-readable media according to claim 17, wherein the instructions, when executed, cause the printing the first base printing layer by causing:
obtaining a theoretical printing trajectory of the first base printing layer;
generating a plurality of consecutive trajectory instructions based on the theoretical printing trajectory of the first base printing layer; and
sequentially executing a plurality of the consecutive trajectory instructions to continuously print the first base printing layer on the object.

19. The one or more non-transitory computer-readable media according to claim 18, wherein the instructions, when executed, cause the capturing the actual printing trajectory by causing:
capturing a plurality of printing trajectory points of the first base printing layer in response to executing the plurality of the consecutive trajectory instructions; and
determining the plurality of the printing trajectory points as the actual printing trajectory of the first base printing layer.

20. The one or more non-transitory computer-readable media according to claim 18, wherein the instructions, when executed, cause the generating the plurality of consecutive trajectory instructions by causing:
dividing the theoretical printing trajectory to generate a plurality of outer wall trajectory instructions, a plurality of inner wall trajectory instructions, and a plurality of filling trajectory instructions.
